(19) United States
(12) Patent Application Publication
(10) Pub. No.: US 2009/0206043 A1
(43) Pub. Date: Aug. 20, 2009

(54) Method and a Device for Collection of Floating Waste on a Water Surface

(76) Inventors: Sven Haagensen, Porsgrunn (NO); Jorn Heimstad, Kristiansand (NO)

Correspondence Address: Andrus, Sceales, Starke & Sawall, 100 East Wisconsin Avenue, Suite 1100, Milwaukee, WI, 53202, US

(21) Appl. No.: 11/547,300

(22) PCT Filed: Apr. 5, 2005
(86) PCT No.: PCT/NO2005/000114

§ 371 Date: Aug. 28, 2008

(30) Foreign Application Priority Data
Apr. 7, 2004 (NO) 20041471

(51) Int. Cl. B63B 35/32; C02F 1/40; E02B 15/04

(52) U.S. Cl. 210/776; 210/170.05; 210/242.3; 210/237

(57) ABSTRACT

A method and a device for collection of floating waste (16), including oil and oil-soiled objects, on a water surface (14) by means of a floating collection arrangement (2) containing at least one waste-receiving portion (8) and at least one collection receptacle (4). An inflow, which consists of the waste (16) and a directly underlying water layer (24), is conducted into the collection receptacle (4) via the receiving portion (8) and separates into an upper waste-containing layer (24) and a lower water layer (26) from which water is conducted out of the collection receptacle (4). The subject matter of the invention is that the inflow (16, 20) is conducted over a threshold (6) that is placed deeper than the water surface (14), and which is provided in the waste receiving portion (8). The water layer (20) acts like a lubricating sliding layer preventing sticky waste (16), for example oil, from adhering to the threshold (6). Such a lubricating sliding layer may also be provided by means of a forced water current (34) established between the threshold (6) and the waste (16) and its underlying water layer (20).

The present invention concerns a method and a device for collecting floating waste on a water surface by means of a floating collection arrangement. The collection arrangement may be in the form of a vessel, but other shapes may also be used. For example, the waste may be oil, oil-soiled objects and/or various other waste objects floating on the water surface due to a buoyancy force, for example due to a density difference between oil and water.

The invention may also be used for further processing of constituents already separated in a collection receptacle. For example, a separated water phase still containing smaller concentrations of residual oil may be further processed in order to separate further amounts of residual oil.

The invention has its origin in problems concerning oil spill protection and water cleaning in oceans, lakes, rivers, etc., and also in harbours and areas adjacent to such bodies of water. Said problems also comprise general cleaning of a water surface, such as collection of various waste/refuse floating on a water surface, and which does not need to be soiled with oil or other adhesive agents.

For the latter purpose, it is known to utilize a collection vessel having a front-free, flat-bottomed container placed at the bow portion thereof, the container also being provided with a flow through bottom grate. During the collection, the vessel travels around on the water surface, for example in a harbour, and collects refuse through the open front portion of the container. Thereby, water is forced out through the grate in the bottom of the container, whereas the refuse is accumulated in the container.

For collection of oil refuses, including oil and oil-soiled objects, floating collection arrangements or -vessels, which are provided with one or more receptacles for collection of the oil refuse, are frequently employed. Frequently, but not necessarily, such an arrangement is connected to another vessel providing propulsion thereof. In this respect, it is also common to employ lengthy collection devices, for example oil booms or similar, extended on the water surface in order to fetch and collect the oil refuse.

Oil spills regularly occur from various activities onshore and at sea. Despite great occasional efforts to restrict dispersion of such oil spills, the spills often reach surrounding beach zones. Both on the water and along such beach zones, considerable amounts of floating objects exist, including general waste, birds and other wildlife, which engage with the oil spill, and which must be handled in a subsequent oil-cleanup operation. Frequently, the collected amount of oil and oil-coated mass therefore is far larger than the amount of the oil spill itself. Oftentimes, suitable equipment for collecting oil and oil-coated waste from the water is lacking.

Oil released on a water surface will also lose its light hydrocarbon components to the air. Thus, the viscosity of the remaining oil will increase considerably, which reduces the mobility and pumpability of the oil. Moreover, when solid objects are present admixed in the oil, known oil spill protection equipment oftentimes will function poorly.

In addition to this unfavourable state of the oil and potential oil-soiled objects, wind- and water current conditions often create further problems for the cleanup operation. For example, a relatively powerful water current and/or wind may cause the oil waste to flow underneath and/or over oil booms or similar collection devices. Oftentimes, this results from a damming up of the oil waste due to the current forces influencing the specific collection device, and/or due to the method used during the collection. When the thickness of the damming up increases, the probability of the oil waste being conducted underneath and/or over an oil boom, for example, increases.

Concerning collection of oil waste, prior art techniques also comprise a number of oil collection devices and methods that are supposed to be less sensitive towards the viscosity of the oil and solid objects in the waste.

Among other things, examples of prior art techniques may be found in patent publications U.S. Pat. No. 3,662,891, U.S. Pat. No. 3,847,815, DE 3416683, BG 2064971 and in SU 958583.

Moreover, DE 3347988 describes a collection vessel provided with an open well in the front portion thereof, in which a conveyor belt conveys oil and objects up from the water to a collection on the vessel.

EP 0357239 concerns a method associated with collection of oil and oil-soiled objects form a water surface by means of a conveyor belt, which is heated. Thereby, the oil is separated more easily from the objects.

The technique according to said DE 3347988 and EP 0357239 is encumbered with the fact that oil having resided in the sea for a relatively short time, is very sticky and viscous. Thereby, the oil-polluted mass easily adheres to the oil collection equipment that it comes into contact with, which considerably reduces the oil collection efficiency.

Furthermore, when collecting thicker oil layers, the method according to EP 0357239 results in a greatly reduced oil collection speed due to the limited thermal conductivity of the oil. This condition prevents the oil from flowing with ease and separating from the conveyor belt and the oil-soiled objects.

NO 154468 refers to an arrangement for transport and damming up of oil, in which a damming-up body is used for this purpose. Preferably, the damming-up body is in the form of a submerged, roller-shaped, roughed-up or brush-shaped rotor, the axis of rotation of which extends transverse to the direction of movement of the barge.

Moreover, U.S. Pat. No. 3,684,095 and U.S. Pat. No. 3,726,406 describe the use of barges and oil booms for collecting oil. An upward water current from nozzles is utilized to lift the oil above the water surface and into the barge.

U.S. Pat. No. 3,630,376 shows a known collection barge having a receiving end and a transverse bow portion. A number of nozzles are provided in front of the bow portion, the nozzles being attached to the barge in front of the bow portion. The nozzles are connected to a pressurized water source and eject an oblique, upward-directed water jet over an overflow crest (or threshold) and further to a collection receptacle in the barge.

Norwegian patent application NO 19910920 also shows an oil collection vessel, for example a barge, utilizing mainly the same collection principle as that of U.S. Pat. No. 3,630,376, i.e. to eject an oblique, upward-directed water current over an overflow crest and further to a collection receptacle in the vessel. The overflow crest is placed more elevated than the surrounding water surface. NO 19910920 also is continued as international publication WO 9215481, subsequently continued as U.S. Pat. No. 5,445,744, EP 0580601 and FI 112518 B, among others.

Said NO 19910920 (and WO 9215481) describes both a method and a device for oil collection. Among other things, nozzles or a rotating paddle wheel to establish said upward-directed water current over said overflow crest, insofar as the overflow crest, when in position of use, is placed more elevated than the surrounding water surface. The water current is to attract water and oil, which is conducted into and in front of the collection vessel by means of suitable collection devices, for example oil booms, which are extended in an oil-collection-focusing manner in front of the vessel. U.S. Pat. No. 5,445,744, however, is restricted to provide said upward-directed water current by means of a paddle wheel. The water current is to contribute to prevent the oil waste from adhering to oil collection equipment that it comes into contact with. However, the water current over the elevated overflow crest will easily create turbulence at the downstream side thereof, dependent on the water's flow rate over the overflow crest. Such a turbulent water current may contribute to form undesirable and troublesome oil/water emulsions on the overflow crest and in the collection receptacle.

Said lifting of the oil waste over the overflow crest also reduces the collection rate of the waste and thus the collection efficiency. The primary reason for this is that the method and the device according to NO 19910920 (and WO 9215481, etc.), among others, pay little respect to flow conditional circumstances.

The present invention, however, is based on fluid mechanical considerations, which may be expressed through the following, simplified formula based on the law of impulse (momentum of mass), conservation of mechanical energy and conservation of mass:

$$\frac{V}{U} = \frac{1}{2} [ 1 + \sqrt{1 + 4 \frac{H}{D} ( 1 - cos θ )} ] .$$

The various parameters of the formula are shown in the following figure:

The figure is schematic and shows a first liquid layer, for example a water layer, which initially flows at a velocity “V” and a layer thickness “D” upward along an inclined plane at an angle of inclination “θ”. This upward-inclined liquid current attracts a second liquid layer, for example an oil layer, which flows horizontally at a velocity “U” and a layer thickness “H” towards the first, upward-inclined liquid layer. The second liquid layer then flows onward on top of the first liquid layer, the liquid layers collectively flowing upward along the inclined plane at a velocity “v” and a layer thickness “h”.

Thus the second horizontal liquid layer is drawn in, or is “sucked up”, at a suck-up velocity “U” expressed by:

$$U = \frac{2 V}{1 + \sqrt{1 + 4 \frac{H}{D} ( 1 - cos θ )}}$$

The formula presupposes little influence from so-called edge effects; that the influence of frictional and gravitational forces is insignificant during the flow; that the density differences between the two liquid layers is insignificant; and that continuous flow exists.

Generally, the formula states that the suck-up velocity “U” of the second liquid layer will decrease at an increasing angle of inclination “θ” on the inclined plane and an increasing thickness “H” of the second liquid layer. If the layer thicknesses of the two liquids are approximately equal, i.e. if “H”≈“D”, the maximum suck-up velocity “U” of the second liquid layer will be equal to the flow velocity “V” of the first liquid layer when the angle of inclination “θ” equals zero, i.e. for horizontal flow of both liquid layers. Thus optimum collection efficiency of the second liquid layer, for example an oil slick, is achieved for horizontal flow of both the first and the second liquid layer. The formula also shows that said prior art technique contributes to an ineffective waste collection.

The object of the present invention is to provide a novel method and device for collecting floating waste on a water surface, in which said disadvantages of prior art is avoided or substantially reduced. The invention particularly contributes to effective waste collection, and readily in combination with prior art collection equipment, such as booms and similar, which conduct the waste toward a suitable collection arrangement. Thereby, oil and floating object, among others, are conducted to the collection arrangement instead of being dammed up in said collection equipment, for example said booms.

The object is achieved as disclosed in the following description and in the subsequent claims.

According to the present method and device, a floating collection arrangement for collection of floating waste, including oil and oil-soiled objects, is used on a water surface. The collection arrangement is associated with at least one waste-receiving portion and contains at least one collection receptacle for the waste. In position of use, the receptacle projects down underneath the water surface. The collection receptacle is not confined to particular receptacle shapes or materials and/or material combinations. Shapes and materials suitable for the present need are employed.

The present method comprises the following method steps:

(A) to conduct an inflow, which consists of the waste and a directly underlying water layer, in through said waste-receiving portion and further downstream into the collection receptacle in order there to separate naturally into an upper waste-containing layer and a lower water layer; and
(B) to conduct water from the lower water layer in a downstream direction out of the collection receptacle, whereby the waste is concentrated in the receptacle. The subject matter of the method is that, in method step (A), said waste-containing inflow is conducted over a threshold which, in position of use, is placed deeper than the water surface, and which is provided in the waste-receiving portion of the collection arrangement.

Said inflow may be conducted in through the at least one waste-receiving portion of the arrangement by moving the collection arrangement relative to the surrounding water surface. The relative movement may be carried out by allowing the collection arrangement to be propelled and steered via its own means, for example by means of own propulsion- and steering means. Alternatively, the collection arrangement may be passive and is moved by means of at least one propulsion vessel, for example booms or similar collection devices being used for collecting and conducting waste toward the collection arrangement.

In this respect, water from the lower water layer may be conducted out of the at least one collection receptacle by allowing the water to flow freely out of it due to displacement in the receptacle, for example via at least one hatchway in the collection receptacle.

The inflow may also be conducted into the collection receptacle by allowing at least one first flow-generating device, for example a pump, a paddle wheel or a pump/nozzle arrangement, to establish an underlying water current driving said water layer and waste over at least portions of said threshold. The water current acts like a lubricating sliding layer preventing any sticky waste from adhering to the underlying threshold and forming flow restrictions thereon. The water current may be laminar or turbulent, dependent on which type of waste is being collected. When collecting oil-containing waste, preferably a laminar water current is used.

The inflow may also be conducted into the collection receptacle by allowing at least one second flow-generating device, for example a pump, a paddle wheel or a pump/nozzle arrangement, to establish and drive a water current from the lower water layer and out of the receptacle, whereby said inflow is drawn in through the waste-receiving portion of the arrangement. When collecting oil and/or oil-soiled waste, this feature will contribute to reduce the danger of emulsifying the oil to form troublesome oil/water emulsions. This will also contribute to increase the oil/water ratio in the collection receptacle, thereby providing potential equipment for further processing of the oil with a least possible amount of water to process further. Thereby, the surface strain on the receptacle is also reduced when used as a separation basin.

Based on the above-mentioned formula, in order to achieve maximum collection efficiency, the collection arrangement may also be provided with both at least one first and at least one second flow-generating device to establish the above-mentioned liquid flow through the collection arrangement.

From said formula it is also evident that the waste collection rate generally increases with an increasing water layer flow rate over the threshold and into the collection receptacle. A strong inflow rate, however, may be difficult to provide under certain conditions, particularly during collection operations in narrow waters/areas or under conditions in which the movement of the collection arrangement cannot contribute to establish a strong water inflow rate. Under such conditions it is desirable to have a forced water throughput by means of said first and/or second flow-generating device(s). Thereby, the water throughput becomes independent of the relative movement or standstill between the collection arrangement and the surrounding water surface.

As a further alternative or addition to the preceding features, water may also be conducted freely or forcedly out of the receptacle via at least one separator device for separation of at least one residual pollutant in the water.

For example, such a separator device may include at least one oil separator for separation of residual oil in the water. Use of such separator devices for further processing of wastewater may be appropriate in places and relations posing high demands on environmental purity.

Said threshold may also be arranged to be adjustable vertically, whereby the draught of the threshold may be adjusted relative to the draught of the waste. Among other things, this renders possible to carry out a faster movement of the collection arrangement without unnecessary amounts of water being admitted.

Moreover, in method step (A) at least a part of the inflow may be conducted with a downward dip into the collection receptacle. This implies that the threshold of the collection arrangement and/or a portion downstream thereof is arranged with a downward dip into the receptacle.

One or both of the latter two features mentioned is/are useful when collecting floating objects with or without a coating of oil. Among other things, the features contribute to push the objects into the receptacle.

At its upstream side, the collection arrangement may also be associated with at least one flow baffle plate in order to guide the waste in through the waste-receiving portion of the arrangement and further into the collection receptacle, whereby the waste is prevented from flowing outside of the arrangement, among other things. One or more such baffle plates may be placed upstream of, at and/or downstream of the threshold.

The at least one flow baffle plate may also be arranged to be moveable, and thereby to be directionally adjustable, whereby the flow path of the inflow into the collection receptacle may be adjusted appropriately.

The method may also comprise a step (C) consisting in shutting off at least the waste-receiving portion of the collection arrangement upon cessation of the waste collection.

The waste-receiving portion and/or the collection receptacle may also be arranged as a separate and releasable unit. Thereby, the waste-receiving portion and/or the collection receptacle may be handled separately from the collection arrangement, including replacing one unit with another unit, for example in order to replace one collection receptacle with another receptacle.

Yet further, the collection receptacle and/or the collection arrangement may be associated with locomotion elements in order to move the receptacle relative to the collection arrangement.

The collection receptacle and/or the collection arrangement may also be provided with at least one lifting point.

The waste-receiving portion may also be arranged as a separate overflow skimmer conducting the waste into an integrated or separate collection receptacle.

Furthermore, the collection receptacle may be arranged to be adjustable vertically, whereby the draught of the receptacle may be adjusted.

By arranging the collection receptacle as a separate and releasable unit relative to the collection arrangement and the waste-receiving portion, the receptacle for example may be elevated from the water so as to get hold of a container hook for lifting the receptacle out of the collection arrangement.

Alternatively, the arrangement and/or the receptacle may be provided with rails or rolls upon which the receptacle may be moved out of the arrangement for subsequent transport of the receptacle, for example by means of container vehicle transport.

As a further alternative, the collection arrangement containing the collection receptacle may be moved, for example lifted, out of the water.

Moreover, the collection arrangement may be arranged to be adjustable vertically, whereby the draught of the arrangement may be adjusted relative to the water surface. This may be useful in order to increase the velocity of the arrangement during movement. For example, this may be achieved by providing the arrangement with buoyancy elements that are displaced vertically in order to adjust the draught of the arrangement in water.

The present invention also comprises a device for collection of floating waste, including oil and oil-soiled objects, on a water surface. Features disclosed in the subsequent claims define the device, but these are essentially also mentioned in connection with the present method.

Subsequently, various examples of embodiments of the invention will be shown, in which:

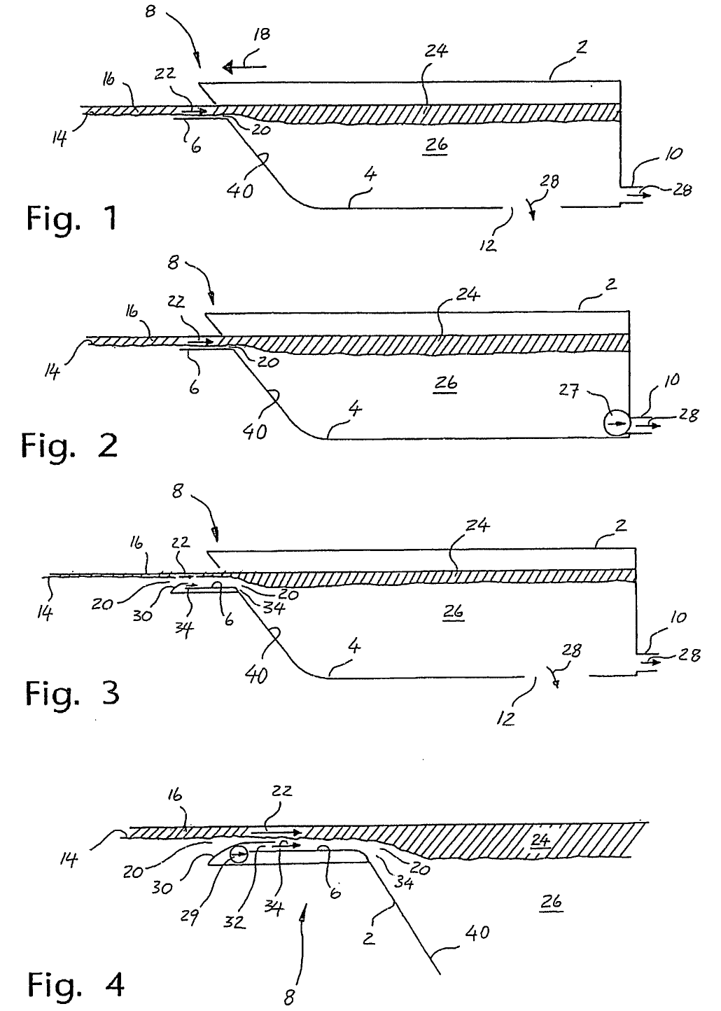

FIG. 1 shows a schematic section through an oil collection vessel moving relative to a surrounding water surface, wherein an oil slick (hachured in all figures) and a directly underlying water layer is conducted passively in through an upstream oil-receiving portion of the vessel, whereas separated water is conducted passively out through the oil collection receptacle thereof via a water outlet and a hatchway at the bottom of the receptacle;

FIG. 2 shows a schematic section through an oil collection vessel being stationary relative to the water surface, wherein the vessel is provided with a forced water outflow through a water outlet at the bottom and downstream side of the vessel's oil collection receptacle, whereas said oil slick and water layer is conducted passively in through the oil-receiving portion of the vessel;

FIG. 3 shows the oil collection vessel according to FIG. 1 placed stationary relative to the water surface, wherein the vessel is provided with a forced inflow in the oil-receiving portion of the vessel, whereas separated water is conducted passively out of the oil collection receptacle via said water outlet and hatchway;

FIG. 4 shows an enlarged cutaway of the oil-receiving portion according to FIG. 3; and

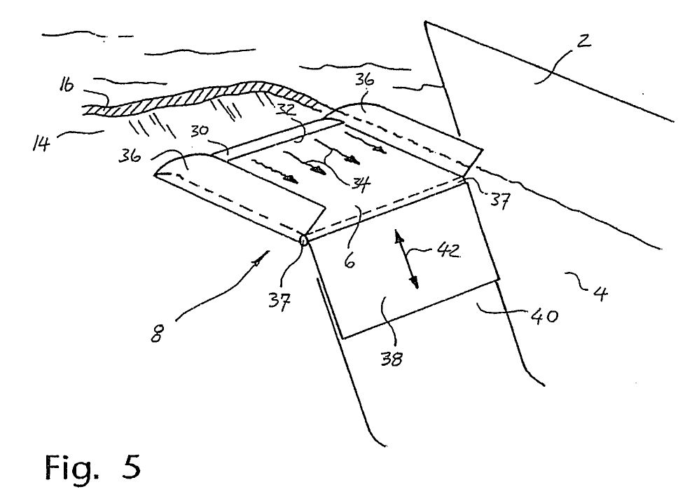

FIG. 5 shows, in perspective, a schematic section of the oil-receiving portion of an oil collection vessel, wherein the receiving portion is provided with flow baffle plates guiding said oil slick and water layer into the oil collection receptacle of the vessel.

FIG. 1 shows an oil collection vessel 2 provided with an internal oil collection receptacle 4 projecting down underneath a water surface 14, and the upstream end thereof being inclined up towards a mainly horizontal and plate-shaped threshold 6 formed in an oil-receiving portion 8 at the bow of the vessel 2. A water outlet 10 and a hatchway 12 are formed at the bottom of the receptacle 4, and at the stern of the vessel 2. The figure shows the collection vessel 2 moving relative to the surrounding water surface 14. Oil in the form of an oil slick 16 floats on top of the water surface 14. The direction of movement of the vessel 2 is indicated with an arrow 18. The figure also shows the threshold 6 placed in position of use at a distance below the water surface 14. Said distance, or draught, is sufficiently large for a water layer 20 to exist between the oil slick 16 and the threshold 6. When the vessel 2 moves relative to the water surface 14, the oil slick 16 and the water layer 20 is conducted collectively and passively in through the receiving portion 8, over the threshold 6 and further downstream into the collection receptacle 4. The water layer 20 acts like lubricating sliding layer preventing oil from adhering to the threshold 6. The direction of inflow is indicated with an arrow 22. In the receptacle 4, the inflow 16, 20 is separated naturally into an upper oil-containing layer 24 and a lower water layer 26 due to their density differences. In this example, water is conducted passively from the lower water layer 26 out of the receptacle 4 via said water outlet 10 and hatchway 12 at the bottom thereof, and at the downstream side of the receptacle 4. The directions of outflow are indicated with arrows 28. Thereby, the oil 16, 24 is concentrated in the receptacle 4.

In FIG. 2, the collection vessel 2 is stationary relative to the water surface 14. Unlike the previous embodiment example, the vessel 2 is provided with a flow-generating device in the form of a pump 27 connected to said water outlet 10 from the oil collection receptacle 4. The pump 27 provides a forced water outflow from the receptacle 4. For example, the device may also be a paddle wheel, a pump/nozzle arrangement and/or an oil separator. Thereby, said oil slick 16 and water layer 20 is drawn passively in through the oil-receiving portion 8 of the vessel 2.

In FIG. 3, the oil collection vessel 2 according to FIG. 2 is stationary relative to the water surface 14. Unlike the embodiment according to FIG. 1, the vessel 2 is provided with a flow-generating device in the form of a pump 29 arranged in a housing 30 upstream of said threshold 6 in the oil-receiving portion 8. The pump 29 establishes a forced water current 34 (indicated as a downstream-directed arrow on the figure) underneath said inflow 16, 20. The forced and underlying water current 34 drives the oil slick 16 and the water layer 20 over said threshold 6. For example, the device in the housing 30 may also be a paddle wheel or a pump/nozzle arrangement. Separated water from the lower water layer 26, however, is conducted passively out of the oil collection receptacle 4 via said water outlet 10 and hatchway 12

FIG. 4 shows an enlarged cutaway of the oil-receiving portion 8 according to FIG. 3. Said housing 30 is provided with a downstream-directed, horizontal outflow slot 32 through which the water current 34 exits underneath the oil slick 16 and the water layer 20 to attract and draw these further into the collection receptacle 4.

FIG. 5 shows, in perspective, the oil-receiving portion 8 of the vessel 2 provided with flow baffle plates to guide the oil slick 16 into the oil collection receptacle 4. Similar to the embodiment example according to FIGS. 3 and 4, the vessel 2 is provided with a pump 29 (not shown) arranged in a housing 30 and ejecting, in this embodiment example, a laminar water current 34 via an outflow slot 32 and onwards underneath the oil slick 16 and the water layer 20. The inflow 16, 20 and the water current 34 is maintained focussed sideways by means of two fixed, immovable side baffle plates 36, one on each side of the plate-shaped threshold 6. Such side baffle plates 36 may also be arranged to be adjustable. The threshold plate 6 is also arranged so as to be able to rotate about a horizontal axis of rotation transverse to the direction of inflow. In this embodiment example, the threshold plate 6 is provided with a horizontal rotary shaft 37 connected on the underside of the threshold plate 6 and at the downstream end thereof. The horizontal axis of rotation may also be placed in another position on the threshold plate 6, for example midway underneath it. By means of the horizontal rotary shaft 37, the threshold plate 6 may be set with a desired angle of inclination downward in the direction of flow, thereby conducting the inflowing liquids 16, 20, 34 with a desired downward dip into the oil collection receptacle 4. A further rotation upwards of the upstream end of the threshold plate 6 may be used to shut off the oil-receiving portion 8. This, for example, may be carried out in combination with the threshold 6 being elevated by means of a elevating—an lowering device (not shown). A movable bottom baffle plate 38 is provided downstream of the threshold 6 and is associated with the forward and inclined wall 40 of the receptacle 4. The bottom baffle plate 38 is arranged sloping downward and into the receptacle 4. In FIG. 5, the bottom baffle plate 38 is shown being mainly parallel to the receptacle wall 40. The bottom baffle plate 38 is arranged to be both vertically and horizontally movable and thus movable both forward and backward along the direction of flow. The direction of movement of the baffle plate 38 is indicated with a two-directional arrow 42 in the figure. By placing the upper edge of the bottom baffle plate 38 at a suitable depth below the oil slick 16, the baffle plate 38 will “shave off” the oil slick 16 from the inflow 16, 20. Thereby, most of the oil slick 16 flows over the bottom baffle plate 38, whereas the remaining and aqueous liquid part 20, 34 is conducted underneath it. At the downstream side, the bottom baffle plate 38 thus contributes to separate the inflowing liquids 16, 20, 34 into said upper oil containing layer 24 and lower water layer 26. The bottom baffle plate also assists in conducting the aqueous liquid part 20, 34 with a desired downward dip into the receptacle 4, which counteracts turbulent flow and emulsification in the oil collection receptacle 4. If desirable, the bottom baffle plate 38 may also be displaced further upwards to assist in shutting off the oil-receiving portion 8.

1. A method for collection of floating waste on a water surface by means of a floating collection arrangement, wherein the collection arrangement is associated with at least one waste-receiving portion and contains at least one collection receptacle for the waste, the receptacle projecting down underneath the water surface (14) when in position of use;
wherein the method comprises the following steps:
(A): by means of at least one first flow-generating device, to generate an underlying and forced water current that drives an overlying inflow, which consists of the waste and a directly underlying water layer, in through said waste-receiving portion, further over at least portions of a threshold which, in position of use, is placed deeper than the water surface, and which is provided in said waste-receiving portion, and then further downstream into the collection receptacle in order to separate naturally therein into an upper waste-containing layer and a lower water layer; and
(B): to conduct water from the lower water layer in a downstream direction out of the collection receptacle, whereby the waste is concentrated in the receptacle, characterized in that the method also comprises the following steps:
to provide the first flow-generating device in a housing upstream of said threshold in the waste-receiving portion; and
to provide the housing with a downstream-directed, horizontal outflow slot through which the water current from the first flow-generating device may exit underneath said inflow so as to drive the inflow into the receptacle, said water current thus also providing a lubricating layer between the inflow and the threshold for preventing waste from adhering to the threshold.

2. The method according to claim 1, characterized in that said underlying water current is generated by means of a first flow-generating device in the form of a pump, a paddle wheel or a pump/nozzle arrangement.

3. The method according to claim 1, characterized in that, in method step (B), water from the lower water layer is conducted passively out of the collection receptacle by allowing the water to flow freely out of it due to displacement in the receptacle.

4. The method according to claim 1, characterized in that, in method step (B), a water current from said lower water layer is generated and driven out of the collection receptacle by means of at least one second flow-generating device.

5. The method according to claim 4, characterized in that said water current out of the collection receptacle is generated and driven by means of a second flow-generating device in the form of a pump, a paddle wheel or a pump/nozzle arrangement.

6. The method according to claim 1, characterized in that, in method step (B), the water is conducted freely or forcedly out of the collection receptacle via at least one separator device for separation of at least one residual pollutant in the water.

7. The method according to claim 1, characterized in that the threshold is arranged so as to be adjustable vertically, whereby the draught of the threshold may be adjusted relative to the draught of the waste.

8. The method according to claim 1, characterized in that, in method step (A), at least a part of the inflow is conducted with a downward dip into the collection receptacle.

9. The method according to claim 1, characterized in that the collection arrangement, at the upstream side thereof, is associated with at least one flow baffle plate in order to guide the waste in through the waste-receiving portion of the arrangement and further into the collection receptacle.

10. The method according to claim 9, characterized in that the at least one flow baffle plate is arranged so as to be moveable, and thereby so as to be directionally adjustable, whereby the flow path of the inflow into the collection receptacle may be adjusted.

11. The method according to claim 1, characterized in that the method also comprises a step (C), which consists in shutting off at least the waste-receiving portion of the collection arrangement upon cessation of the waste collection.

12. The method according to claim 1, characterized in that at least one of the waste-receiving portion and the collection receptacle is arranged as a separate and releasable unit, whereby it/they may be handled separately from the collection arrangement.

13. The method according to claim 12, characterized in that at least one of the collection receptacle and the collection arrangement is associated with locomotion elements in order to move the receptacle relative to the collection arrangement.

14. The method according to claim 12, characterized in that at least one of the collection receptacle and the collection arrangement is provided with at least one lifting point.

15. The method according to claim 12, characterized in that the waste-receiving portion is arranged as a separate overflow skimmer conducting the waste into an integrated or separate collection receptacle.

16. The method according to claim 1, characterized in that the collection receptacle is arranged so as to be adjustable vertically, whereby the draught of the receptacle may be adjusted.

17. The method according to claim 1, characterized in that the collection arrangement is arranged so as to be adjustable vertically, whereby the draught of the arrangement may be adjusted relative to the water surface.

18. The method according to claim 1, characterized in that the collection arrangement is used for collection of at least one of floating oil and oil-soiled objects on the water surface.

19. A device for collection of floating waste on a water surface by means of a floating collection arrangement;
wherein the collection arrangement is associated with at least one waste-receiving portion and contains at least one collection receptacle for the waste, the receptacle projecting down underneath the water surface when in position of use;
wherein the collection arrangement is provided with at least one first flow-generating device capable of generating an underlying and forced water current for driving an overlying inflow, which consists of the waste and a directly underlying water layer, in through said waste-receiving portion, further over at least portions of a threshold which, in position of use, is placed deeper than the water surface, and which is provided in said waste-receiving portion, and then further downstream into the collection receptacle in order to separate naturally therein into an upper waste-containing layer and a lower water layer; and
wherein water from the lower water layers is conducted in a downstream direction out of the collection receptacle, whereby the waste is concentrated in the receptacle, characterized in that the first flow-generating device is provided in a housing upstream of said threshold in the waste-receiving portion; and
wherein the housing is provided with a downstream-directed, horizontal outflow slot through which the water current from the first flow-generating device may exit underneath said inflow so as to drive the inflow into the receptacle, said water current thus also providing a lubricating layer between the inflow and the threshold for preventing waste from adhering to the threshold.

20. The device according to claim 19, characterized in that the first flow-generating device is comprised of a pump, a paddle wheel or a pump/nozzle arrangement.

21. The device according to claim 19, characterized in that the collection arrangement is provided with at least one second flow-generating device that generates and drives a water current from said lower water layer and out of the collection receptacle.

22. The device according to claim 21, characterized in that the second flow-generating device is comprised of a pump, a paddle wheel or a pump/nozzle arrangement.

23. The device according to claim 1, characterized in that the collection arrangement is provided with at least one separator device through which the water is conducted freely or forcedly out of the collection receptacle, the at least one separator device being arranged for separation of at least one residual pollutant in the water.

24. The device according to claim 23, characterized in that the at least one separator device includes at least one oil separator for separation of residual oil in the water.

25. The device according to claim 19, characterized in that the threshold is arranged so as to be adjustable vertically, whereby the draught of the threshold is adjustable relative to the draught of the waste.

26. The device according to claim 19, characterized in that at least one of the threshold of the collection arrangement and a portion downstream thereof is arranged with a downward dip into the collection receptacle.

27. The device according to claim 19, characterized in that the collection arrangement, at the upstream side thereof, is associated with at least one flow baffle plate in order to guide the wasted in through the waste-receiving portion of the arrangement and further into the collection receptacle.

28. The device according to claim 27, characterized in that the at least one flow baffle plate is moveable, and thereby directionally adjustable, whereby the flow path of the inflow into the collection receptacle is adjustable.

29. The device according to claim 19, characterized in that the waste-receiving portion of the collection arrangement is arranged so as to be shut off upon cessation of the waste collection.

30. The device according to claim 19, characterized in that at least one of the waste-receiving portion and the collection receptacle is arranged as a separate and releasable unit, whereby it/they may be handled separately from the collection arrangement.

31. The device according to claim 30, characterized in that at least one of the collection receptacle and the collection arrangement is associated with locomotion elements in order to move the receptacle relative to the collection arrangement.

32. The device according to claim 30, characterized in that at least one of the collection receptacle and the collection arrangement is provided with at least one lifting point.

33. The device according to claim 30, characterized in that the waste-receiving portion is arranged as a separate overflow skimmer that conducts the waste into an integrated or separate collection receptacle.

34. The device according to claim 19, characterized in that the collection receptacle is arranged so as to be adjustable vertically, whereby the draught of the receptacle is adjustable.

35. The device according to claim 19, characterized in that the collection arrangement is arranged so as to be adjustable vertically, whereby the draught of the arrangement is adjustable relative to the water surface.

36. The device according to claim 19, characterized in that the floating waste is comprised of at least one of oil and oil-soiled objects.
